(19) United States
(12) Patent Application Publication
(10) Pub. No.: US 2010/0166240 A1
(43) Pub. Date: Jul. 1, 2010

(54) Hearing apparatus for pets

(76) Inventor: Richard W. Prior, Lancaster, CA (US)

Correspondence Address: Richard W. Prior, 4379 Paddock Way, Lancaster, CA, 93536, US

(21) Appl. No.: 12/317,515

(22) Filed: Dec. 27, 2008

(51) Int. Cl. H04R 25/00

(52) U.S. Cl. 381/326

(57) ABSTRACT

An apparatus that provides vibration cues, indicative of ambient sounds, to deaf and hard-of-hearing pets. This apparatus, attached to a pet's collar, receives sounds via an attached microphone, processes said sounds to discriminate changes in sound patterns or to detect specifically-programmed sound patterns, and then outputs vibrations that are indicative of the received sounds.

### CROSS-REFERENCE TO RELATED APPLICATIONS

Provisional Patent Application:
U.S. Pat. No. 2,694,059

### STATEMENT REGARDING FEDERALLY-SPONSORED RESEARCH OR DEVELOPMENT

Not Applicable

### FIELD OF INVENTION

The present invention relates generally to hearing devices and specifically to devices that allow deaf or-hard-of-hearing pets to gain additional awareness of their surroundings.

### BACKGROUND OF THE INVENTION

Pets, like people, can lose their sense of hearing, and for some, it may become more than a quality-of-life issue. In some situations, safety may be a concern, and having the ability to respond to a loud noise or a pet owner's voice could ameliorate some of the danger.

Prior art addresses part of the hearing-loss issue through the use of remotely-activated vibrating collars (U.S. Pat. No. 6,598,563). Generally, these devices are radio-frequency controlled and, although primarily intended as a training aid for dogs with normal hearing, the devices can be used to alert a pet that would not otherwise respond to a verbal command.

In each case, however, the pet owner presses a button on the remote, subsequently sending a signal to the pet's collar, causing it to vibrate, thereby getting the pet's attention. The problems with this method are two-fold; a) someone needs to push a button to get the pet's attention, and b) many noises—critical or otherwise—remain unnoticed by a deaf or hard-of-hearing pet.

In other prior art, hearing aids, similar to the human variety, have been modified for use on pets, particularly dogs, however their success is limited, primarily because many dogs seem averse to foreign objects that are placed within the ear canal. Often, the dog will scratch at its ear until the device falls out. And for totally-deaf pets, a human-type hearing aid would have essentially no benefit.

At present, pet owners are extremely limited as to the number of methods they have to ameliorate a pet's loss-of-hearing condition.

### SUMMARY OF THE INVENTION

The present invention, while not restoring any part of a pet's hearing, allows a deaf or hard-of-hearing pet to have an increased acoustic awareness of its surroundings. It is non-surgical and does not require that a pet owner or trainer be nearby for the device to function.

A primary objective of this invention is to discern selected sounds and to generate specific patterns of vibrations that can be felt by an animal that has this invention attached to its collar.

A further objective is to provide unique vibration patterns that correspond to specified input sounds.

A still further objective is to provide said functions in a small-size, light-weight, affordable device.

A still further objective is to provide an apparatus that is energy efficient.

A still further objective is to provide an apparatus that minimizes false activations in the presence of on-going ambient sounds such as TV, music, conversations, and machinery.

### BRIEF DESCRIPTION OF THE DRAWINGS

FIG. 1 is a block diagram of the present invention.

FIG. 2 is a perspective drawing of a preferred embodiment of the present invention.

FIG. 3 is a perspective drawing of a second preferred embodiment of the present invention.

FIG. 4 is a detailed schematic of a preferred embodiment.

FIG. 5 is an exemplary audio waveform and resulting detected waveform that are applied to the invention's microcontroller (uC).

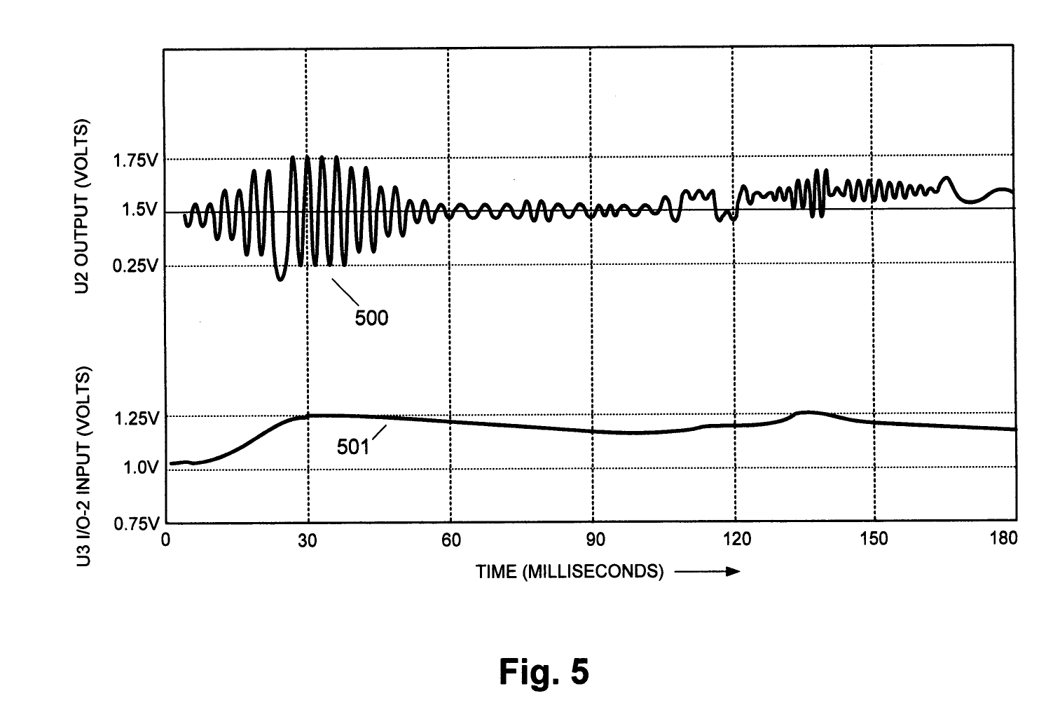

FIG. 6 is an exemplary detected signal that results from spoken words.

FIG. 7 is an exemplary detected signal that results from music.

FIG. 8 is an exemplary detected signal that results from approaching traffic.

FIG. 9 is an exemplary detected signal that results from a voice command.

FIG. 10 is an exemplary control signal waveform that is applied to the vibrator circuit.

FIG. 11 is an exemplary software flowchart.

### DETAILED DESCRIPTION OF THE INVENTION

A detailed description of the present invention is provided below with reference to the figures. While illustrative component values and software functions are given, other embodiments can be constructed by those familiar with the art.

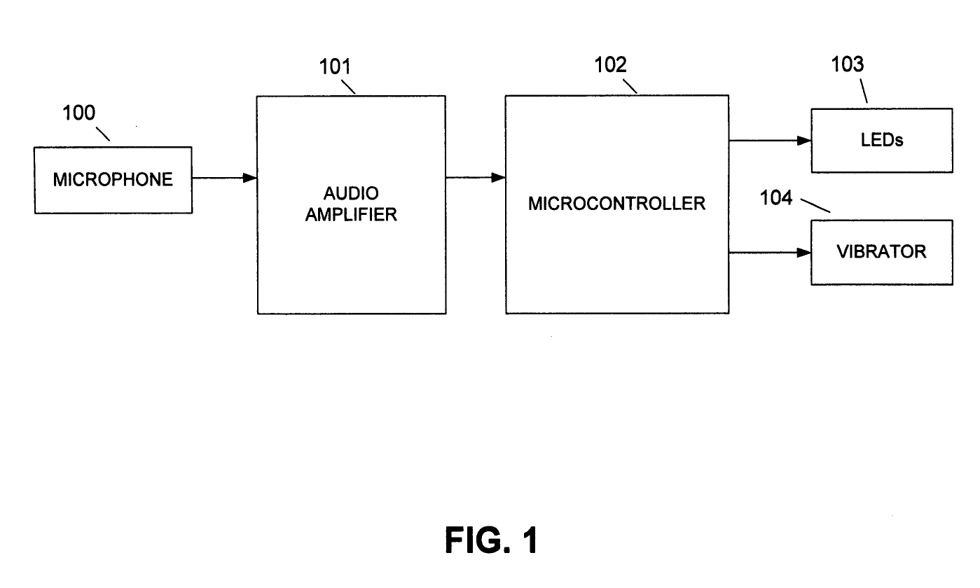

FIG. 1 depicts the main sections of the present invention, less the power source. The power source itself, including, but not limited to, “AAA” to “D” sized battery or batteries, uses standard-in-the-industry techniques to provide the 3 volts required by the circuitry, and, as such, not described in detail. Likewise, additional circuit features such as reverse-battery protection and low-voltage design are also industry-standard and therefore not discussed.

A preferred embodiment, as described below, uses two AAA batteries to provide the 3 volts required for the uC, vibrator, and supporting electronics.

While intended primarily for dogs, cats, and horses, any hard-of-hearing or deaf animal, sufficiently strong to wear this invention (including the appropriately-sized battery), might benefit from its use.

Item 100 is a low-cost, small electret microphone that is sensitive to normal household noises, the frequencies of which are typically in the range of 50 Hz to 2000 Hz. Human voice typically falls within the range of 80 Hz to 600 Hz, and many loud noises that a pet might need to hear, such as a knock on a door or a dinner bowl on a counter, have significant frequency components within the 50 Hz to 2000 Hz range. By itself, a microphone, even with a built-in field effect transistor (FET) does not provide sufficient signal amplitude for a microcontroller (uC) 102 to process, so an audio amplifier 101 provides gain to bring the signal level to an easily-processed level. An audio signal gain of 500 for low-level sounds is sufficient for many applications of this invention.

Item 102 is a standard low-power uC such as supplied by Microchip™ or Atmel™ which typically includes appropriate analog-to-digital converters. Because, for this embodiment, only modest speed, RAM, and power are required, the choice of a specific uC heavily depends on implementation and features that are included with the application.

The number of input and outputs (I/O) required by the uC for a preferred embodiment is two for input and three for output. Because this invention relies on battery power, the current drain of the uC and supporting electronics is a concern, however, battery lifetime is heavily dependent on the current required by the vibrator 104 and also how often the vibrator is activated. A main objective of the uC code is to minimize power by optimal selection of uC operating speed and selective activation of the vibrator.

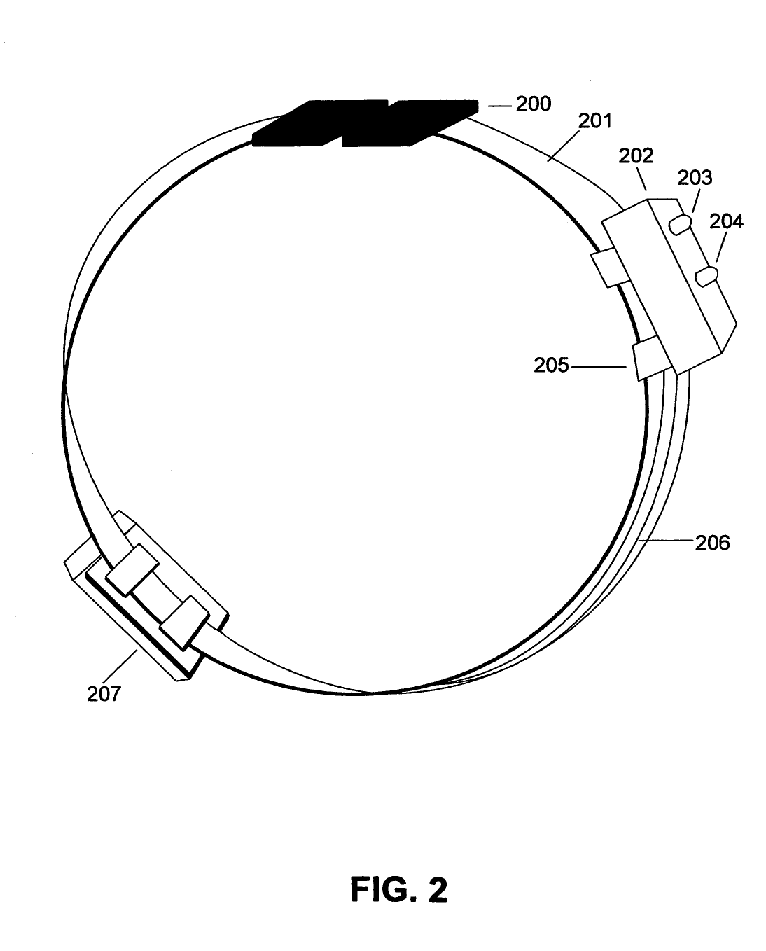

FIG. 2 depicts the present invention in a preferred embodiment wherein items 100-104 (FIG. 1) are housed in a waterproof enclosure 202 that is attached to a pet's collar 201 via a clip-on or tightly-gripping clamp 205. For said preferred embodiment the microphone 100 is housed totally within the enclosure. Although some sound-level attenuation occurs with a totally-enclosed microphone, normal signal levels remain within the analog processing capability of many microcontrollers. By placing the microphone within the enclosure, significant cost savings can be realized.

The batteries, within enclosure 207, are connected to the main electronics unit via low-voltage wires 206 that are sufficiently protected from weather elements and protected from expected wear and tear.

A pet's sensitivity to vibrations depends, in part, to the tightness of the vibrator with respect to the pet's skin and also depends on the amplitude of vibrations. In normal usage, gravity will tend to keep the center of mass of the electronics assembly 202 and heavier battery 207 at a low point on the pet's neck. A split arrangement (battery and electronics) as shown in FIG. 2 allows several advantages. The microphone stays near the pet's ear and easily picks up ambient sounds. And even if said collar is relatively-loose, the vibrator housing 202 can maintain sufficient contact with the pet's neck and readily transmit vibrations. Also, by separately locating the battery compartment, assembly 202 is lighter in weight and can allow larger amplitude vibrations.

The present invention, for manufacturing reasons, can be fabricated as an integral part of the pet's collar 206 including the collar clasp 200 or, as shown in the FIG. 2 embodiment, can be supplied as a separate unit that attaches to an existing pet's collar.

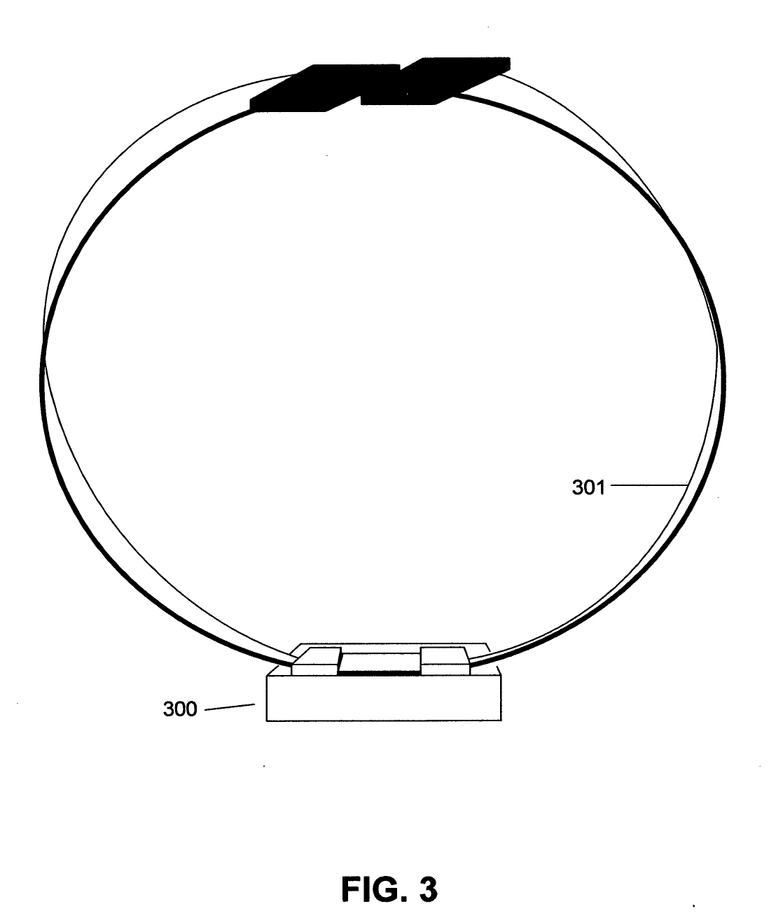

FIG. 3 depicts another preferred embodiment, that, for cost reasons, houses both battery and electronics in a single enclosure 300 that attaches to the pet's collar 301. Although gravity will tend to keep the unit low on a pet's neck and perhaps buried in fur, the low-cost advantages may outweigh some reduction in sound sensitivity. An elastic collar may provide closer contact of the enclosure to the pet's neck, thereby increasing sensitivity, however the elasticity of said collar may preclude its use as a normal pet collar. Overall, a single housing such as shown in FIG. 3 can provide a low-cost alternative to the split arrangement as shown in FIG. 2 with some potential loss of sound sensitivity or battery lifetime (larger or longer vibrations may be used with the tradeoff of higher power).

Alternative embodiments to those shown in FIG. 2 and FIG. 3 can include provisions for harness-type straps that minimize overall apparatus movement and keep the apparatus in an optimal top-of-the-neck or back area. Similarly, various combinations of sensor and battery enclosures should be readily apparent to those familiar with the fabrication of dog collars and restraints.

A primary objective of this invention is to allow a useful battery life of at least a month, preferably two or more. Battery life of less than a month has several downsides. There may be times—between battery change—that the apparatus is not powered and therefore useless. Also frequent changes of batteries may discourage human users from routine maintenance, thereby denying a pet the full advantage of sound awareness.

One major obstacle to overcome when considering a vibrator to communicate the presence of ambient sounds is the issue of vibrator current. Depending of the vibration amplitude desired, vibrator current can range from 50 millamperes to 150 milliamperes. Given that a AAA battery has a capacity of about 500 milliampere-hours, extensive use of a vibrator, especially in a noisy environment, would cause the battery to reach its end-of-life in about a day.

To overcome said obstacle this invention uses software coding and electronics to process ambient sounds by these steps; a) characterize received sounds, b) determine if received sounds require that a pet be alerted, and c) if an alert is required, activate the vibrator.

Once the pet has been alerted, said pet can subsequently look around to see the source of the sound. Using this approach, the number of alert signals, depending on the pet's environment, can be limited to about 10 to 100 activations a day, and this is well within the capacity of a small battery, especially if the activations are of fractional seconds.

Software coding can also be optimized to further limit the vibration activations in presence of continued sounds such as TV, music, or operating machinery. With such noisy backgrounds, normal-hearing pets quickly become accustomed and “lose interest” in the sound. Only significant changes in sound (level, composition, etc.) will grab the pet's attention. It is a primary objective of this invention to emulate said characteristic of normally-hearing pets. From a pet's perspective not all sounds are interesting, and thus by limiting the vibrator activations only for “interesting” sounds, battery lifetime is significantly increased.

It is also an objective of this invention to reduce the startle effect of vibrator activation. Although pets can quickly associate a vibration with the occurrence of a nearby activity, a sleeping dog might be roused too suddenly with an unexpected vibration and become averse to the hearing apparatus. This invention addresses this issue by two methods. Firstly, after a long period of vibrator silence, the first alert vibrations are subdued. Subsequent vibrations can be stronger to more firmly alert the pet. Secondly, a motion detector, such as a low-cost rolling ball switch can be used to identify a “sleeping dog.” Thus a long period of inactivity (no motion detected) would indicate a sleeping dog. Vibration activations could therefore be subdued until the pet is sufficiently roused (also detectable via said motion sensor) and more acceptant of stronger vibrations.

In many circumstances it is desirable for an owner to get his pet's attention. This may be for safety concerns or simply to get the pet to come, sit, stay, etc. Typically for deaf pets, the owner will touch, nudge, or wave to get the pet's attention then follow-up with an appropriate hand signal. The problem here is readily apparent; whenever the owner is out of the pet's sight, said owner must move close enough to touch the pet—often inconvenient if done many times a day. By using the present invention with appropriate audio cues, the task of getting a deaf pet's attention is greatly simplified.

Such sounds such as a whistle at a specific frequency, a single loud clap, a double clap (U.S. Pat. No. 5,493,618), a single spoken pre-programmed word, several pre-programmed words, or a user-defined phrase based on the user's own voice might be considered as audio cues to activate this invention remotely. However, implementing said remote-control function in a real-world environment of TV, traffic, machinery, stereos, alarms, and people is challenging. The present invention overcomes these challenges via the following methods.

The sensing unit uC software “listens” for a pre-programmed phrase wherein: a) the phrase comprises two distinct words (such as, “Puppy . . . Come!), b) the phrase timing is used as a qualifier, and c) the phrase is easily remembered. Also the phrase includes “plosive” sounds that have relatively-high volume and, as such, are easier to time via software. Words such as “listen,” “see me,” or “look,” while perhaps having identifiable frequency content, require much more signal processing than amplitude-strong sounds such as the first syllable in “Puppy” or “Kitten,” or the “C” enunciation in the word “Cat.” Foreign language phrases which include two “plosive” sounds are also acceptable as voice commands.

Furthermore, automatic gain control (AGC) is employed specifically to adjust sound qualification thresholds according to the average or peaks of ambient sounds that had been received by the sensing unit within a several-second or several-minute time period. Thus it should not be required that a user use a loud voice in a quiet room to activate the invention's vibrations.

Voice commands are also further qualified based on a “quiet time” before and after a potential command. To discern voice commands in the midst of TV noise or on-going conversations, this invention requires that a relatively-quiet period precede the command, subsequently followed by a quiet period after the command. Typically the required time is from a half-second to two seconds, depending on ambient noise. By doing so, noise immunity is greatly enhanced, as real-world noises rarely present a sound sequence such as relative quite, followed by a double peak, followed by relative quiet.

Although AGC allows the present invention to function in a wide variety of ambient noise situations, it may be difficult for a user to judge both the required amplitude and timing of an acceptable voice command. To significantly ease said task, two readily-visible LEDs are provided on the sensing apparatus (items 203 and 204 of FIG. 2), the functioning of which is described via the following preferred embodiment example.

A yellow LED 203 momentarily illuminates upon sensing a qualified first peak (the “P” vocalization in “Puppy”). After a short delay (typically 500 milliseconds), red LED 204 illuminates and remains on during a permitted second-peak timing window (typically an additional 300 milliseconds). Thus if the user enunciates, “Come” during the red LED flash and does so with the proper volume, alert vibrations are subsequently activated (contingent on the aforementioned before-and-after quiet times).

If the user provides insufficient voice-command loudness to activate the first-peak trigger, the yellow LED does not illuminate, so the user can try again-with a louder voice.

Additionally, both LEDs could simultaneously flash indicating a successful voice command. This is a key user-feedback feature as the vibrator response may or may not be human audible.

Furthermore, the flashing LEDs, much like a simple video game, encourage users to invoke voice commands, thus enhancing a pet's ability to associate vibrations with nearby activity. This is especially crucial during the initial phase wherein a pet becomes accustomed to vibration activations; pleasant associations (and many of them) can allow a pet to quickly increase its awareness of nearby sounds and activities.

By combining the aforementioned methods, an effective, low-cost voice command hearing apparatus can be manufactured. Other voice-command embodiments, using commonly-available microcontrollers and implementing variations of AGC for loudness, timing, and sound content, can readily be developed by those familiar with the art.

In addition to voice command response, it is an objective of this invention's software to be able to discern other specific sounds or sound events and output correspondingly-unique vibration patterns. Such a capability can substantially increase a pet's awareness of its environment.

As exemplary applications, several varied situations are considered. For instance, an approaching lawn mower or a sounding smoke alarm may be indicative of a nearby hazard, thus requiring a strong vibration alert. A nearby barking dog might indicate an interesting nearby activity thus prompting medium-strong alert vibrations. However, a morning alarm clock or a voice command might elicit a normal-level alert—just enough to get a pet's attention.

It is a primary objective of this invention to discern “important” sounds, but achieving said objective, amidst a tremendous variety of background noises, presents numerous challenges. The present invention achieves said objectives while minimizing false triggers by using AGC to manage signal levels and by using software to categorize sounds according to the following; a) single-event loudness, b) change in the average or integral of sound intensity over a short time, c) change in the average or integral of sound intensity over a relatively long time. Each of these categories is further detailed below.

The category of single-event peak loudness comprises sounds wherein sound intensity levels exceed a certain threshold (loudness) for a brief period, such as a second or less. This category would include sounds such as a shout, a clap, a door slam, or a pet's dinner bowl banging on a countertop. A preferred embodiment of this invention adjusts said threshold sufficiently high such that only exceptionally-loud, single-event sounds trigger a vibration response.

The second exemplary category of sound is based on characterizing sounds over a short time such as 5 seconds. Specifically, the uC listens for sounds wherein there is a substantial increase in received sound intensity yet said sound event contains minimal or no “quiet” moments. Examples of this sound category include traffic noise, approaching lawn mowers, approaching vacuum cleaners, and energized power tools such as saws, drills, kitchen blenders, etc. Typically such noises may prompt a medium-strong vibration response.

The third exemplary category of sounds is based on characterizing sounds over a relatively-long period such as 10-30 seconds. Specifically, the uC listens for sound events that contain numerous changes in momentary sound intensity. Examples of this type of sound include a TV switched on after a long silence, a morning alarm clock, music, and people entering a room and conversing. Such sounds are characterized by numerous “relatively-quiet” moments that exist between spoken words or music segments. Because said method is based on signal integration, a loud relatively-short sound, such as an alarm clock, can produce an integrated signal that is comparable to that produced by, again as example, a normal—but long—conversation. Appropriate software could provide further signal discrimination, but often this category of sound indicates non-hazardous but attention-deserving situations, thus prompting a mild to medium vibration response.

In other embodiments, uC software could also examine sounds for specific events such as a smoke alarm sounding. Said sound is easily identifiable via its loud and periodic character. Other sound-specific events such as a door bell ringing or a whistle sounding can also be identified via specific sound-search algorithms, and such embodiments should be readily apparent to those familiar with the art.

By categorizing sounds in the above manner, many common situations that might affect or interest a pet can be sensed appropriately and distinguished from ordinary noise. And as mentioned earlier in this disclosure, often-repeated noises could, via this invention's software, further limit the strength or number of vibration responses, similar to a normally-hearing pet “losing interest” in a common sound. By limiting the strength or number of vibrations, two benefits are realized; a) said pet is less likely to become de-sensitized to vibrations, (too many false triggers may lead to pet inattention), and b) significant reduction in battery power is possible.

Although several embodiments of this invention have been described, there are numerous other embodiments of software code that could further discriminate the aforementioned sounds or further define correspondingly-unique vibration patterns. Many of said embodiments can readily be implemented on commonly-available microcontrollers by one familiar with industry-standard software and/or hardware methods. Also, if one is familiar with general sound characterization or animal behavior, further refinements of this invention should be readily apparent.

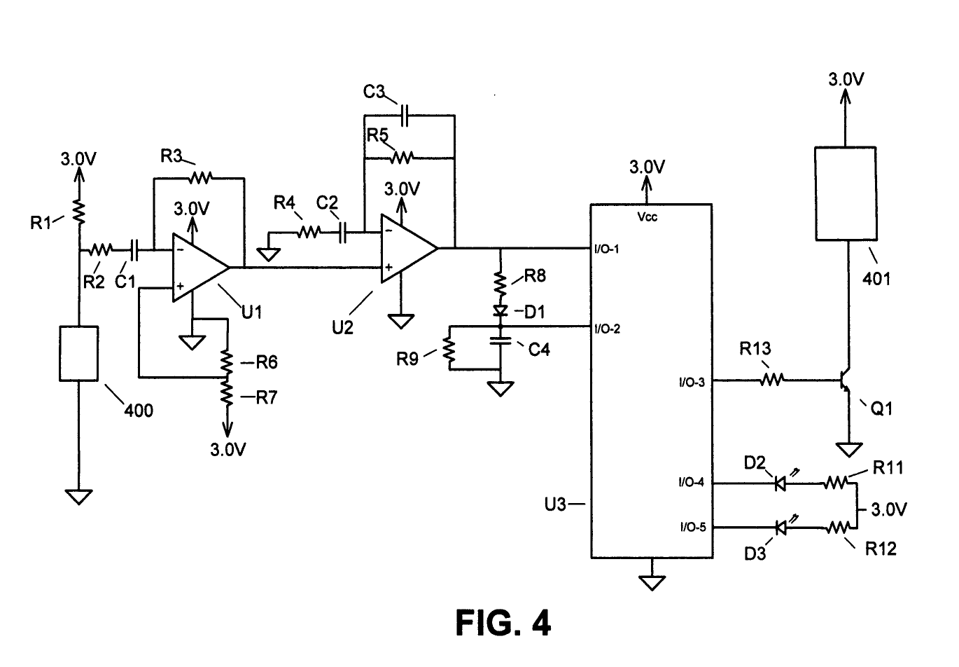

FIG. 4 is a detailed schematic of a preferred embodiment that comprises a microcontroller (U3) and audio circuit and allows implementation of the aforementioned features. Significant power savings can also be realized in said embodiment by using microcontroller algorithms that are not computational intensive, i.e., a low frequency clock allows low-power operation.

Unless otherwise stated, the following description pertains to the FIG. 4 preferred embodiment. Electret microphone 400, with built-in field-effect transistor (FET), is applied with a 3-volt bias via resistor R1, typically 2K ohms. The small—several millivolt—signal produced by the microphone in the presence of typical sounds is amplified via a common bandpass amplifier comprising U1, U2, and circuit components R2, R3, R4, and R5 (typically 20K, 1M, 20K, and 200K respectively) and C1, C2, and C3 (typically 0.1 uF, 1 uF, and 470 pF). This amplifier configuration allows a small-signal gain of about 500 which is sufficient for many common sounds. As depicted, the circuitry of U1 and U2 (which can be a dual operational amplifier such as the LPV358) provide a filter with a bandpass range of about 80 Hz to 1.8 KHz; 80 Hz is primarily set via R2 and C1, and 1.8 KHz via R5 and C3.

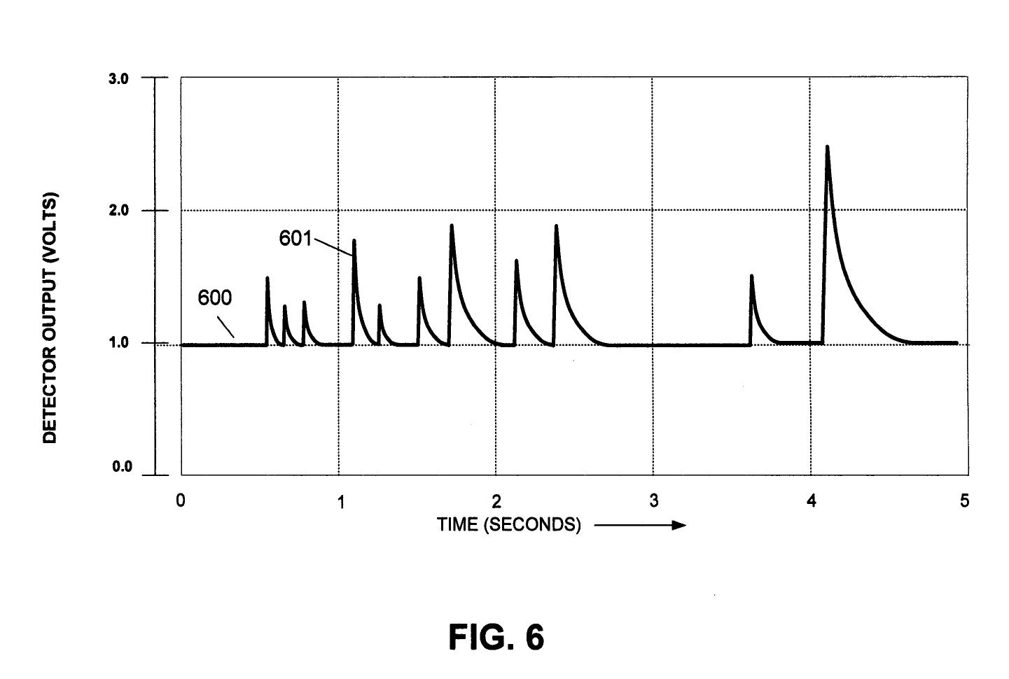

R8 (4.7K), D1 (a common signal diode such as the IN4148), and C4 (1 uF) form a detector that develops a DC signal at U3 input pin, I/O-2, that is proportional to the peak AC signal at the U2 output. FIG. 6 depicts an exemplary waveform wherein U2 output signal 500, about 300 Hz and 0.5 Vp-p, results in a slowly-changing peak-detected signal 501 of about 1.25 V (change in signal voltage of 0.25 V) that is applied to U3 I/O-2 input analog-to-digital conversion circuitry.

Subsequent to a decreasing sound level, R9 (200K) discharges C4 with a time constant of 0.2 second, thus allowing restoration of the no-sound signal level. The aforementioned circuit configuration allows sufficient signal discrimination for most common sounds.

Under no-signal conditions (no ambient sounds) the R6 and R7 (1M, 1M) junction voltage forces the U1 and U2 outputs to about 1.5 volt. This DC bias is also applied to the anode of D1, and because a small current flow flows through D1 and R9 under no-signal conditions, the normal DC voltage at the D1 cathode (U3 pin I/O-2) is about 1 volt.

This configuration permits about 2V peak-to-peak signals and is sufficient for most sound processing. The value of R8 is not critical and mainly serves to limit the current output of U2 while C4 is being charged.

For most signals of interest the voltage across C4 (U3 I/O-2 input) reaches a peak within 50 milliseconds after the sound intensity increases and begins to subsequently decrease for two reasons; a) most attention-getting sounds are “burst” waveforms (such as a loud voice or a knock on a door) that quickly peak and then decay, and b) R9 begins to discharge C4 at a time constant of about 0.2 second.

FIGS. 6-9 are depictions of exemplary time-domain signals that may be applied to the uC input.

FIG. 6 depicts a signal that is typical of in-room conversations. Vocalizations 601 result in numerous signal spikes with “in-between” signal levels that quickly return to quiescent voltage 600.

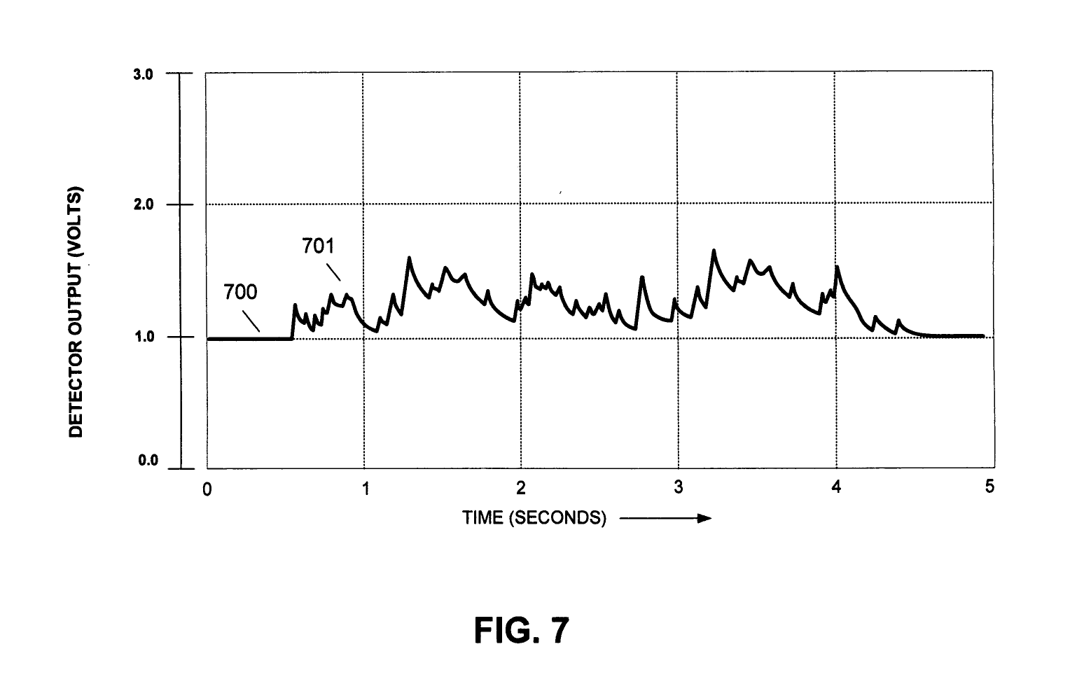

FIG. 7 depicts a signal that typically results from nearby music; numerous signal spikes 701 occur, however signal levels return to a quiescent “no-sound” level 700 much less frequently (compared to conversation signals).

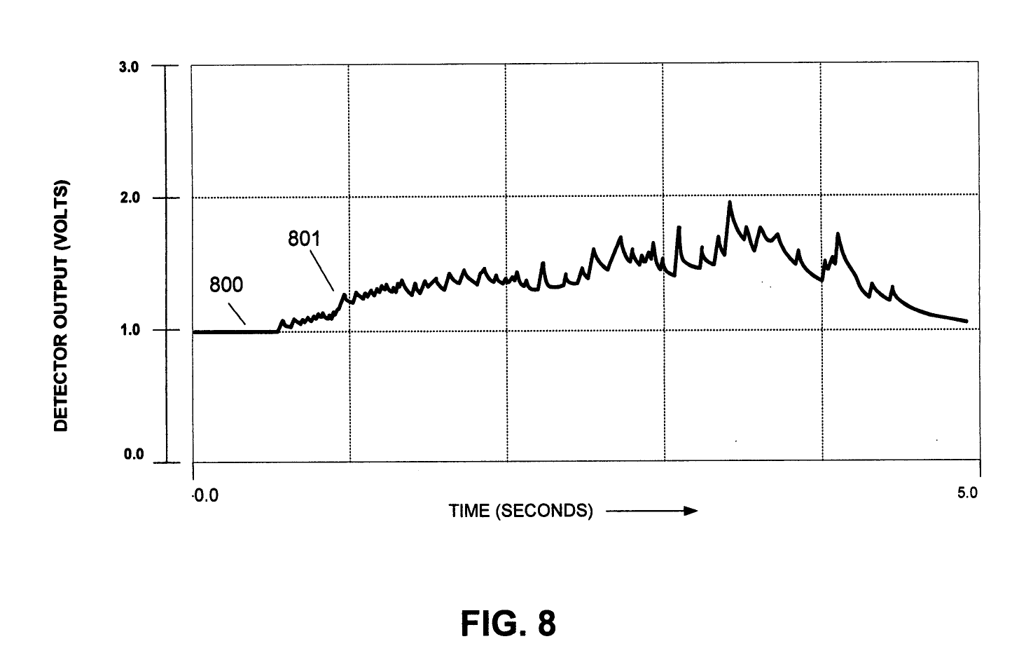

FIG. 8 depicts an exemplary signal that might result from approaching traffic; signal spikes 800 are minimal with regard to momentary peak-to-peak amplitude, and said signal does not return to quiescent level 800 until said traffic passes. FIG. 8 also depicts a signal that is characteristic of an approaching vacuum cleaner or lawn mower.

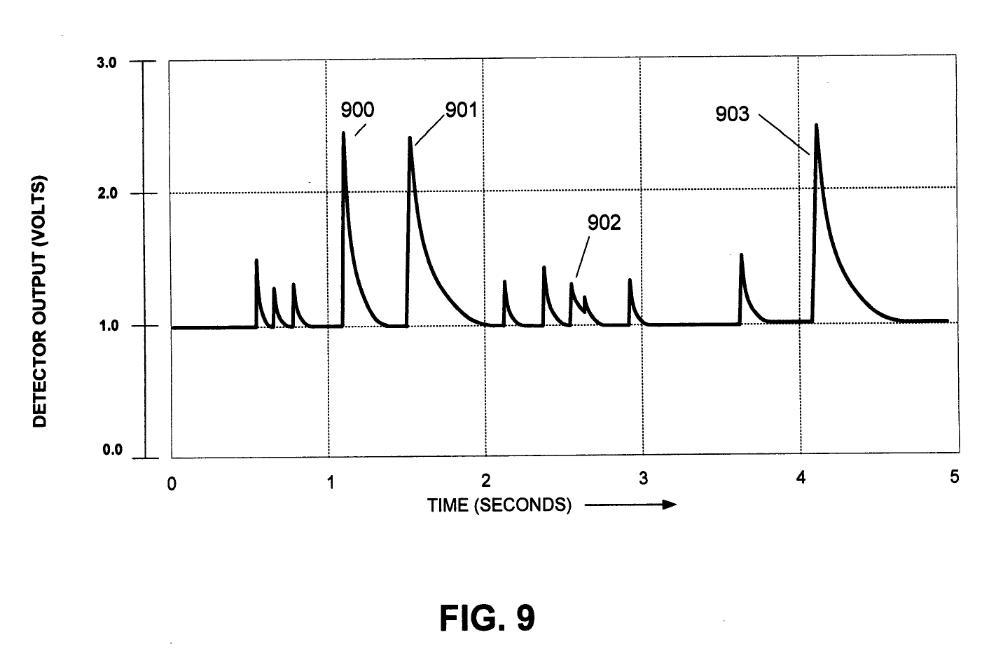

FIG. 9 waveform is comparable to FIG. 6 conversation waveform, however two vocalization spikes 900 and 901 depict a properly-timed voice command. Said spikes, about 600 milliseconds apart, can be readily discriminated (via uC software) from ambient sounds 902 or stand-alone, single-syllable vocalizations 903.

As shown in FIG. 4 the uC output for the preferred embodiment comprises three output pins (I/O-3, I/O-4, and I/O-5) that respectively connect to; a) vibrator control comprising resistor R13 (1K), NPN switching transistor Q1, and vibrator 401, b) LED D2 (typically yellow) and current-limiting resistor R11 (1K), and c) LED D3 (typically red) and current-limiting resistor R12 (1K).

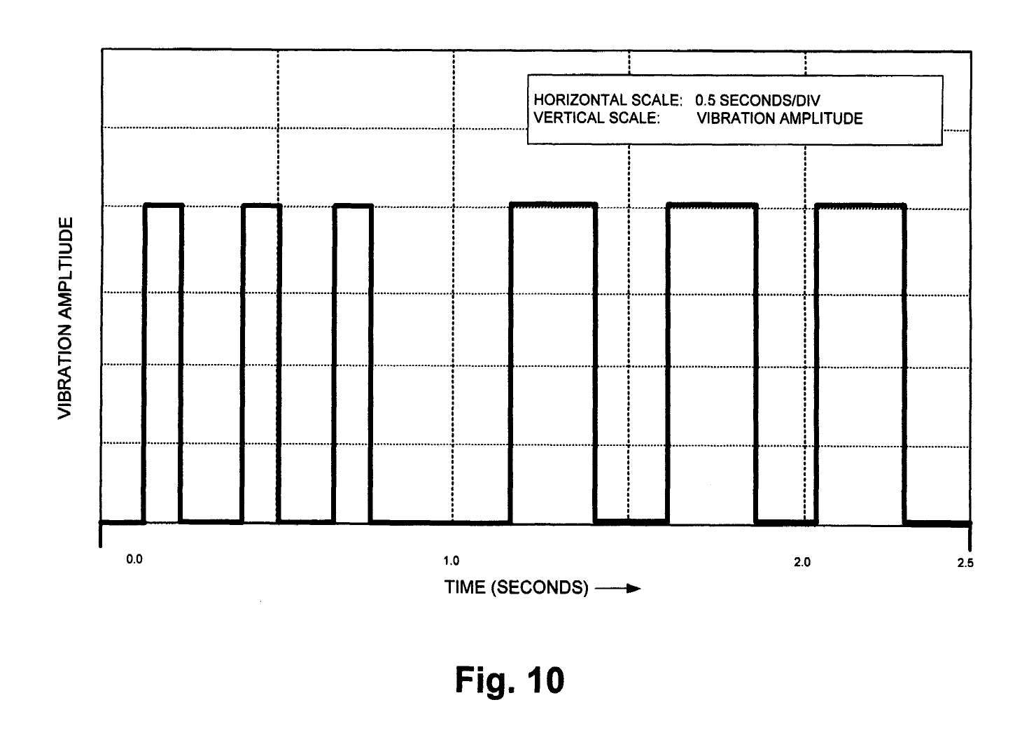

FIG. 10 depicts an exemplary uC output signal that is applied to R13. A high-level output (about 2.5V) turns on said vibrator, a low-level (about 0 V) turns it off. Although pulse-width-modulation (PWM) methods can be used to further modulate vibration amplitude, FIG. 10 depicts a vibration signal that includes three short pulses followed by three long pulses. Said vibration method minimizes the pet-startle effect that might occur if long vibration pulses are applied with no precursors.

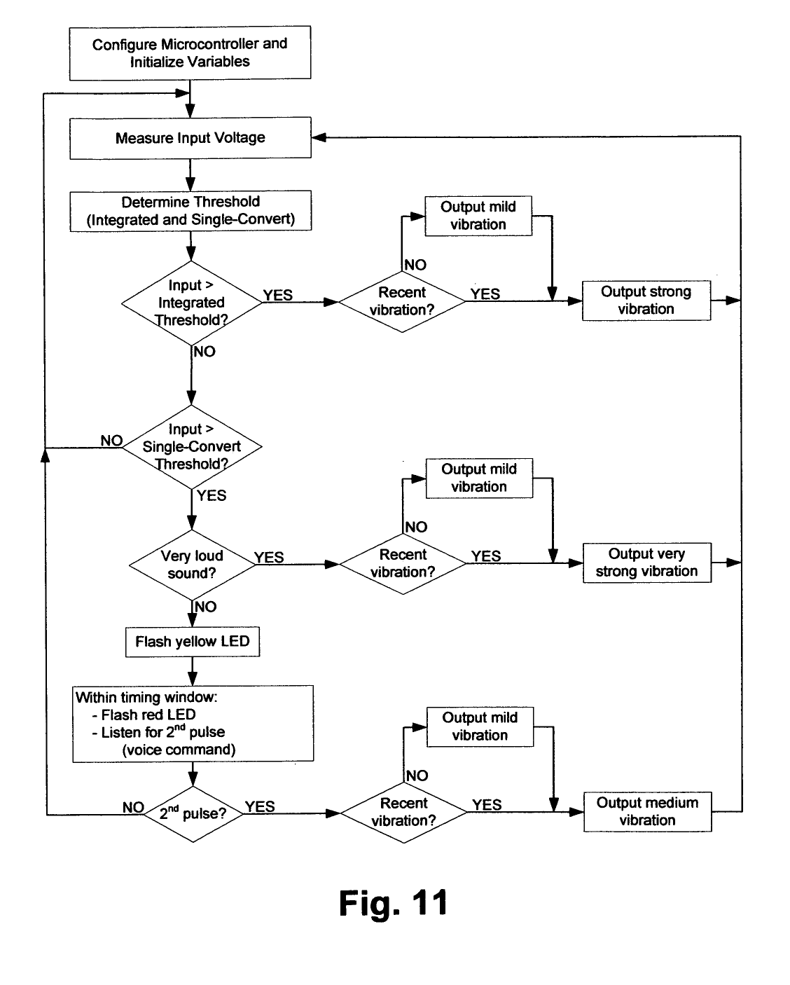

Given the above considerations it is possible to define a flowchart (FIG. 11) for a uC in a moderately-featured embodiment, and the following disclosure, as referenced to FIG. 11, details said flowchart.

As is standard with many uC applications, input and output pins are configured first, along with initialization of variables. Next the uC measures the detected analog signal via a slow analog-to-digital (A/D) conversion; each conversion requiring approximately 200 microseconds. Said measurement is done every 50 milliseconds or so, compared against trigger thresholds and loops until the measurement exceeds said threshold. Said thresholds, for this embodiment, are determined for three sound categories; integrated sounds, loud single-event sounds, and voice commands.

Depending on ambient noise levels, said thresholds can be set lower during quiet periods or higher if, for example, a nearby TV is left on. By appropriately adjusting thresholds, numerous false-trigger alerts can be avoided, and battery power can be conserved. Subsequent to a signal exceeding a threshold, the uC determines the appropriate response.

If, for example, approaching traffic produces a signal comparable to that shown in FIG. 8 and the signal exceeds a computed integrated-signal threshold, the uC triggers a vibration alert that is indicative of a potential hazard. Also, depending on how quickly said integrated signal increases, the delay (sound-to-vibration alert) may vary, i.e., fast-approaching or nearby traffic can trigger a faster alert than with slow-moving or distant traffic. Furthermore, as shown in FIG. 11, if no recent vibrations have been invoked, said alert is prefaced with a mild vibration, thus reducing a startle response in a pet.

Also, in reference to FIG. 11, a very loud noise, such as a door slam, generates an immediate alert. Again, said alert is accompanied, if required, by a mild vibration preamble. Repeated loud sounds, such as made by a hammer in constant use, can trigger immediate alerts with no mild-vibration preamble and do so until the uC raises the corresponding threshold, thus allowing reduced sensitivity to repeated noises.

In the FIG. 11 preferred embodiment, the uC also “listens” for properly-timed voice commands, and as previously described, upon detecting a qualified first pulse (for example, the first “P” in “Puppy . . . Come!”) the uC flashes a yellow LED to indicate so. Subsequently the uC flashes a red LED, indicating the acceptable window to enunciate, again as example, “Come” in the “Puppy . . . Come!” voice command.

Although FIG. 11 depicts an exemplary flow chart for a preferred embodiment, other more-fully-featured embodiments are possible, and several of these embodiments are described below.

Sound recognition capability may be enhanced by digitizing the pre-detected audio signal. Thus, as shown in FIG. 4, the output of U2 is applied directly to U3 analog-to-digital input pin I/O-1. Although more battery power is required with a uC operating at higher digitizing and processing speeds, excessive power consumption can be mitigated by activating high-speed (5 KHz, for example) digitization only for appropriate trigger events. i.e., until certain sound thresholds are exceeded, said uC remains in a standby, low-current state. Thus, upon crossing said threshold, the uC collects high-speed signal samples and subsequently performs an audio analysis. Said analysis could range from basic counting of signal peaks (corresponding to short-term frequency measurement) to a full fft (fast Fourier transform) analysis.

Voice recognition methods are common in the audio and cell phone industry, and as such, are not detailed in this disclosure beyond stating that the required hardware for such a voice-activated hearing apparatus is included in the present invention.

Another embodiment of this invention recognizes that for many housebound dogs, someone ringing a doorbell or knocking at the front door is an important event. In said embodiment, said sound can easily be communicated to a deaf dog if a separate sensor is placed, for example, on or near the front door of a household and, upon detecting a relatively-loud and appropriate sound, transmits a specifically timed sound to the pet's hearing apparatus (wherein the hearing apparatus listens for specifically-timed signals). The uC of this invention would thereby indirectly detect said doorbell sound and subsequently output a specific vibration alert on said pet's collar. Thus, the sound of a generic door bell or knock on the door, normally difficult to discriminate from other background sounds, is converted to a readily-identifiable sound that can be received and interpreted at a greater distance.

Similarly, if this invention is coupled with an auxiliary low-power RF receiver, and the aforementioned exemplary doorbell detector is complementarily equipped with an RF transmitter, the doorbell sound could thus be indicated. The process would be; a) a person rings a doorbell, b) a sensor near the door detects the sound, c) said sensor sends a coded RF signal to a pet's RF receiving collar, and d) and subsequently this invention outputs a vibration alert to said pet. Thus, an RF-coupled system can allow greater range for specifically-indicated sounds.

Further augmenting RF capabilities, a handheld RF transmitter, typically the size of a key FOB can extend an owner's communication with said pet and do so with a wide range of transmit codes and correspondingly with a wide range of vibration alerts.

Yet another embodiment of this invention includes LED indicators that are used with, or in place of, vibration means, thus providing a normally-sighted pet an additional alert means. Said light source (a single LED or a plurality of LEDs) are placed on a muzzle-like means, directing low-intensity light back to said pet's eyes, wherein said light (intensity, pulse rate, direction, etc.) can further indicate the nature of nearby sounds. Also, it may not be required that said light be aimed directly at a pet's eyes. An LED light source mounted on or nearby this invention's sensor (item 202 of FIG. 2) can aim light, for example, towards a pet's nose or towards a floor in front of the pet—as long is said light is visible by the pet, sufficient alert may be possible. Although said LED embodiment may require additional hardware such as collar or harness guides and may require a vibration pre-alert (in case a pet has its eyes closed), the LED low-current requirement (2-20 mA instead of 150 mA for a vibrator) may offset some of said concerns. Thus, a low-current, LED-based sound indicator could substantially extend battery life.

Several embodiments of the present invention have been disclosed wherein a variety of sound detection methods and sound alert methods are discussed, however, further embodiments, with regard to both sound discrimination and pet alert methods should be readily apparent to those familiar with one or more of the following disciplines; audio processing, voice recognition, uC software coding, digital processing hardware, and pet (dog or cat) behavior.

What is claimed is:

1. A sound receiving apparatus wherein said apparatus is wearable by an animal and said apparatus comprises; a) a battery power source; b) a microphone and audio amplifier; c) a signal processing means comprising a method to distinguish input sounds according to frequency, amplitude, tone combinations, patterns of sound, or changes of said sounds; and d) an electrically-powered vibration means that is controlled by said signal processing means and is indicative to said animal of received sounds.

2. An apparatus of claim 1 wherein said vibrations are modulated to include changes of vibration amplitude or frequency, a burst of vibrations or a plurality of bursts, or any combination of said modulation methods

3. An apparatus of claim 1 wherein a plurality of microphones and signal processing means are used to indicate the direction of a received sound.

4. An apparatus of claim 1 wherein a visual indication, such as an LED display, is used with, or in lieu of, the vibration means.

5. An apparatus of claim 1 wherein a visual indication, such as an LED or plurality of LEDs, provides cues to a human regarding the quality of voice commands applied to said apparatus.

6. An apparatus of claim 1 wherein said signal processing method includes human-user-defined sound patterns.

7. An apparatus of claim 1 wherein said vibration patterns include human-user-defined sequences.

8. An apparatus of claim 1 wherein said vibration means comprises a poke or prod means wherein the pressure, duration, frequency, or number of pokes or prods is indicative of said claim 1 input sound patterns.

9. An attachment means wherein said claim 1 apparatus is placed on an animal via a collar, harness, or other non-surgical means.

10. A means of claim 9 wherein said means includes elastic or other flexible material to tightly couple said claim 1 vibrations to the animal's skin.

11. A handheld, manually-operated remote means to activate the vibration means of claim 1 apparatus wherein said remote means communicates to the claim 1 apparatus via audio-range, ultrasonic, infra-red, or RF means.

12. An apparatus of claim 1 wherein a human user can remotely activate specific vibration modes of the claim 1 apparatus.

13. An apparatus remotely located to the apparatus of claim 1 that augments sound-processing capabilities and communicates to said apparatus of claim 1 via audio-range, ultrasonic, infra-red, or RF means.

14. An apparatus of claim 1 wherein said apparatus includes a motion sensor indicative of the animal-user's motion and wherein signals from said motion sensing are processed via software to further modify the vibration modes of claim 2.
